(19) United States
(12) Patent Application Publication
(10) Pub. No.: US 2026/0180397 A1
(43) Pub. Date: Jun. 25, 2026

(54) COMPACT GEAR MOTOR

(71) Applicant: Moving Magnet Technologies, Besançon (FR)

(72) Inventors: Antoine Foucaut, Montarlot les Rioz (FR); Damien Laforge, Chemaudin et Vaux (FR)

(21) Appl. No.: 19/396,821

(22) Filed: Nov. 21, 2025

Related U.S. Application Data
(63) Continuation of application No. 17/996,167, now abandoned.

(30) Foreign Application Priority Data
Apr. 15, 2020 (FR) FR2003796

(51) Int. Cl. H02K 7/116; F16H 1/46; F16H 49/00; F16H 57/02; F16H 57/021; F16H 57/023; H02K 11/33

(52) U.S. Cl. CPC H02K 7/116; F16H 1/46; F16H 49/001; F16H 49/005; F16H 57/021; F16H 57/023; H02K 11/33; F16H 2057/02034

(57) ABSTRACT

The present invention relates to a traction motor module, the module including a fixing shaft formed with a flange unit, a traction motor including a housing fixed at the fixing shaft, a stator fixed at an inner lateral wall of the housing, a rotation shaft arranged at a space formed by the stator and protruded from the housing, and a rotor including a magnet arranged between the stator and the rotation shaft, and a hub unit encompassing the traction motor in a cylindrical shape and rotatably coupled to the fixing shaft.

### CROSS-REFERENCE TO RELATED APPLICATIONS

This application is a continuation of U.S. application Ser. No. 17/996,167, filed Oct. 13, 2022, which is a national phase entry under 35 U.S.C. § 371 of International Patent Application PCT/FR2021/050667, filed Apr. 15, 2021, designating the United States of America and published as International Patent Publication WO 2021/209723 A1 on Oct. 21, 2021, which claims the benefit under Article 8 of the Patent Cooperation Treaty to French Patent Application Serial No. FR2003796, filed Apr. 15, 2020.

### TECHNICAL FIELD

The present disclosure relates to the field of rotary gear motors combining, in an integrated manner, an electric motor of the brushless type with a mechanical reduction gear having a significant axial compactness, for example, of the trochoidal or epicyclic type.

Preferably, but non-limitingly, the present disclosure will find use in various automobile applications, such as, for example, for the actuation of a valve flap, of a needle for adjusting the flow rate of a liquid, of a camshaft phaser, etc.

### BACKGROUND

Already known in the state of the art are documents presenting gear motors integrating the motor and reduction gear functions in the same housing. For example, U.S. Patent Publications US2018022397 and U.S. Pat. No. 9,303,728 present associations of brushless electric motors with reduction gears of the trochoidal (or cycloidal) type. In these solutions, the output shaft is separated from the shaft of the electric motor and positioned downstream of the motor. The motor shaft is guided by imposing bearings at the rear and at the front of the motor, and the output shaft is guided by rolling bearings and main bearings. Several large rolling bearings (single and double) are therefore necessary in these solutions, which are hardly compact.

Also known is U.S. Pat. No. 9,041,259, which presents the association of a brushless motor with a planetary (or epicyclic) reduction gear in which an output shaft passes through the motor upstream in order to allow position detection and to guide this shaft upstream of the motor. This solution, although more compact than the previous ones, requires two rolling bearings to guide the motor shaft and a rolling bearing and a main bearing to guide the output shaft. This results in significant production complexity and a non-optimal compactness.

These known devices are not economically satisfactory, with a large number of components required to ensure the guiding of the rotating elements, in particular, several rolling bearings and main bearings that increase the cost of the devices and generate a non-optimal axial size due to the relatively large size of these guide elements.

In particular, in the known devices, the output shaft on the one hand and the rotor assembly on the other hand are guided by rolling bearings supported by the motor housing. This results in, in particular, a risk of concentricity defect due to manufacturing tolerances that can negatively impact the performance of the motor and of the reduction gear, particularly the efficiency, the reversibility and the wear of the latter.

### BRIEF SUMMARY

It is an object of the present disclosure to propose a more economical and more compact solution for a gear motor by minimizing the size and the number of dedicated guide elements, such as main bearings and rolling bearings, and by having this function supported by elements that are already present in the gear motor. It also aims to ensure perfect coaxiality of the output shaft and the rotor.

In the solutions of the prior art, a misalignment of the rolling bearings of the output shaft and of the rotor assembly leads to a hyperstatic system with a risk of blocking or degraded operation of the system (performance, noise, reduced duration life).

For this reason, the present disclosure more particularly relates to a gear motor comprising an electric motor and a mechanical speed reduction gear, the electric motor having a cylindrical wound stator assembly forming a free interior space and a rotor assembly guided inside the interior space, the reduction gear being inside a housing secured to the stator assembly and having a movable gearing assembly, the output of the movable gearings being secured to a movement output shaft, the input element of the movable gearings being driven by the rotor assembly extending inside the housing, the gear motor comprising a guide element of the output shaft, the output shaft being extended inside the motor up to a guide element located at least partly inside the stator assembly, wherein the rotor assembly is guided by a guide means positioned between the inner surface of the rotor assembly and a surface of the output shaft.

According to different variants, taken separately or in any and all technically feasible combinations:
the guide means is constituted by a rolling bearing,
the guide means is constituted by a plain bearing,
the guide means comprises a coaxial combination of a rolling bearing and the tubular sleeve of a flange secured to the stator assembly,
the stator assembly is overmolded by an injectable plastic material forming a support element in the interior space for guiding the output shaft,
the support element is a cylindrical bore receiving a rolling bearing or a main bearing in which the output shaft is guided,
the support element is a cylindrical bore directly guiding the output shaft,
the guide support element is a plain bearing obtained by a cylindrical bore directly produced in the overmolding of the stator assembly,
the guide support element is an insert bearing,
the housing and the overmolding are extended laterally by corresponding fixing eyelets,
the molded stator is inside a flange, the housing and the flange being extended laterally by corresponding fixing eyelets,
the input element having, on its periphery, a serrated shape working mechanically with a fixed serrated shape secured to the housing,
the gear motor has a fixed serrated internal shape that is secured to the housing,
the fixed serrated internal shape of the housing is made in the housing so as to form one and the same part,
the fixed serrated internal shape of the housing is made directly in the material of the housing, or in the overmolding of the stator assembly,
a ring made of a very rigid material is inserted at the outer periphery of the serrated internal shape,
gear motor has a serrated internal shape made in an output disc secured to the output shaft, the serrated shape cooperating with a gear wheel having axial extensions or cavities cooperating with cavities or axial extensions secured to the housing so as to allow eccentric rotation of the gear wheel,
the mechanical reduction gear is of the trochoidal type,
the input element of the movable gearings being a gear wheel having a serrated shape on its periphery cooperating mechanically with the serrated internal shape,
the mechanical reduction gear is of the epicyclic type,
the mechanical reduction gear is of the elliptical or deformation wave type,
the output element of the movable gearings is an output disc, secured to the output shaft, the output disc and the gear wheel being axially secured using hooks,
the output element of the movable gearings is an output disc, secured to the output shaft, the rotor assembly and the output disc being axially pre-stressed,
the rotor and disc assembly is axially pre-stressed,
the gear motor comprises a printed circuit located between the stator and the bottom of the housing, or the flange on the rear of the stator assembly, the circuit comprising a position sensor, for example, a magneto-sensitive probe, a Hall probe, cooperating with a magnet attached to the output shaft,
a magnetic actuator inserted in the interior space brakes the rotation of the rotor assembly modulated by its power supply,
the magnetic actuator blocks the rotation of the rotor assembly in the event of a fault in its power supply, and
the magnetic actuator leaves the rotor assembly free to rotate in the event of a power supply failure.

### BRIEF DESCRIPTION OF THE DRAWINGS

The present disclosure and its features and advantages will be better understood from the following detailed description of example embodiments of the present disclosure, given by way of example, with reference to the accompanying figures, in which:

FIG. 1 is a sectional view of a first embodiment of a gear motor according to the present disclosure;

FIG. 2 is an exploded perspective view of the embodiment shown in FIG. 1;

FIG. 3 is a sectional view of a second embodiment of a gear motor according to the present disclosure;

FIG. 4 is a sectional view of a third embodiment of a gear motor according to the present disclosure;

FIG. 5 is a sectional view of a fourth embodiment of a gear motor according to the present disclosure;

FIG. 6 is a sectional view of a fifth embodiment of a gear motor according to the present disclosure;

FIG. 7 is a sectional view of a sixth embodiment of a gear motor according to the present disclosure;

FIG. 8 is a sectional view of a seventh embodiment of a gear motor according to the present disclosure;

FIG. 9 is a sectional view of an eighth embodiment of a gear motor according to the present disclosure;

FIG. 10 is a sectional view of a ninth embodiment of a gear motor according to the present disclosure;

FIG. 11A is a sectional view of a tenth embodiment of a gear motor according to the present disclosure;

FIG. 11B is an exploded view of a monostable magnetic actuator of the gear motor of FIG. 11A;

FIG. 12 is an exploded perspective view of the embodiment shown in FIG. 11A;

FIG. 13 is a sectional view of an eleventh embodiment of a gear motor according to the present disclosure;

FIG. 14 is an exploded perspective view of the embodiment shown in FIG. 13;

FIG. 15 is a sectional view of a twelfth embodiment of a gear motor according to the present disclosure;

FIG. 16 is an exploded perspective view of the embodiment shown in FIG. 15;

FIG. 17A is a perspective view in partial section of a thirteenth embodiment of a gear motor according to the present disclosure;

FIG. 17B is an exploded perspective view in partial section of the embodiment shown in FIG. 17A;

FIGS. 18A and 18B are exploded perspective partial sectional views of a fourteenth embodiment of a gear motor according to the present disclosure;

FIGS. 18C and 18D are axial and radial sectional views, respectively, of the embodiment shown in FIGS. 18A and 18B; and

FIG. 19 is an exploded perspective view of a fifteenth embodiment of a gear motor according to the present disclosure.

### DETAILED DESCRIPTION

In general, the gear motor comprises an electric motor (200) associated with a mechanical reduction gear (210). The electric motor (200) comprises a stator assembly (2) and a rotor assembly (26). The mechanical reduction gear (210) has a movable gearing assembly, the output element of the movable gearing assembly being secured to a movement output shaft (19). The input element of the movable gearing assembly is driven by the rotor assembly (26).

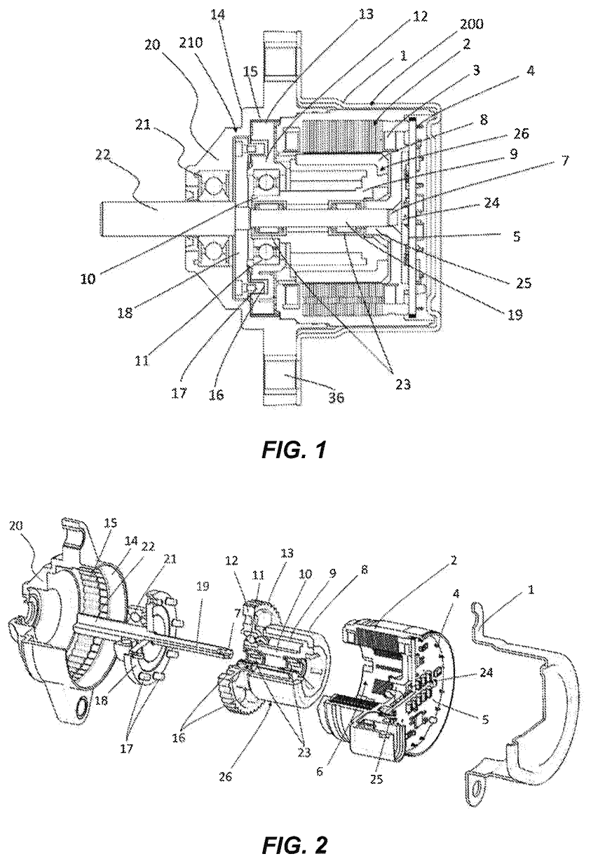

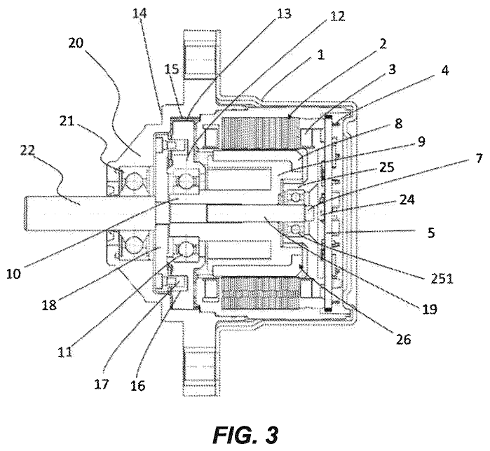

FIGS. 1 and 2 show a first embodiment of a gear motor according to the present disclosure. In this example, the gear motor comprises a flange (1) inside which the stator assembly (2) of the brushless electric motor is positioned. This stator assembly (2) is in the form of an assembly of ferromagnetic laminations overmolded in a plastic material in order to promote the holding of the electrical windings (3). The electrical windings have connections (4) at their ends of the press-fit type that allow the electrical supply of the windings from a printed circuit (5) located on the rear of the stator assembly (2). This circuit comprises a magnetic position measurement probe (24), for example, a Hall probe, positioned in the extension of the output shaft (19). This printed circuit (5) may comprise all or part of the electronic components allowing the control of the motor. This embodiment does not limit the present disclosure, and the connection of the motor coils can be made using copper tracks (or a “lead-frame”) if, for example, the required power is high. The printed circuit (5) can then be removed or retained if it is necessary to have one or more position sensors intended to measure the position of the output shaft (19) of the movable gearing assembly or of the rotor assembly (26). The layout of the printed circuit (5) between the stator assembly (2) and the flange (1) allows very compact integration while promoting the evacuation of heat generated by the printed circuit (5) using the flange (1).

The stator assembly (2) is cylindrical in shape about the axis of rotation of the electrical motor and defines a free interior space (6) in which a rotor assembly (26) is placed, typically but not limitingly in the form of a magnetic ring (8) secured to a support (9) that may or may not have magnetic properties. This embodiment of the rotor assembly (26) is not limiting with respect to the present disclosure, and other embodiments conventionally used by those skilled in the art, for example, without magnets or with magnets inserted in or on a ferromagnetic yoke, are contemplated. The magnets can also be fully or partially located in the stator assembly (2). The support (9) is extended toward the front of the rotor assembly (26) by a shaft (10) to which the inner ring of a rolling bearing (11) is secured in such a way that the axis of rotation of the rolling bearing has an eccentricity with respect to the axis of rotation of the rotor assembly (26). The outer ring of the rolling bearing (11) is secured to a disc-shaped gear wheel (12) having a serrated shape (13) at its periphery. Of course, the present disclosure is not limited to a rotor assembly (26) located entirely inside the stator assembly (2), but extends to any type of arrangement that a person skilled in the art would consider. By way of example, the rotor assembly (26) may have a bell shape so as to accommodate the stator assembly (2) within it while remaining guided by the output shaft (19) passing through the stator assembly (2). One can also imagine an axial flux configuration well known to those skilled in the art for which the magnetically active parts of the stator assembly (2) and of the rotor assembly (26) face each other in the axial direction of the motor, the rotor assembly (26) nevertheless remaining guided inside the stator assembly (2).

The stator assembly (2), secured to the flange (1), is inserted into a housing (14), forming an integral whole. The housing (14) has a serrated internal shape (15) that cooperates with the serrated shape (13) of the gear wheel (12) so that the gear wheel (12) performs a cycloidal movement when driven by the rotor assembly (26) via the eccentric rolling bearing (11). Embodiments with multiple wheels (12) are also contemplated but not shown. The serrated shape (15) of the housing is preferably produced directly in the material of the housing (14) forming only one single part as shown here, or else can be produced as an independent part added to the housing (14) if, for example, for robustness requirements, the serrated shape must be made of a material with better mechanical strength than the housing (14). The gear wheel (12) has a set of cavities (16) within which the axial extensions (17) of an output disc (18) are positioned. This output disc (18) is guided in rotation about the axis of rotation of the electric motor by an output shaft (19). Due to the cycloidal movement of the gear wheel (12) and the rotational guidance of the output disc (18), the output disc (18) is driven in rotation according to a mechanical reduction ratio imposed by the number of teeth of the serrated shapes (13, 15) cooperating according to the teachings of the state of the art on trochoidal-type reduction gears. Obviously for those skilled in the art, the axial extensions (17) can alternatively be fixed and secured to the housing (14), the housing (14) then serving as a support for the gear wheel (12). Thus, the gear wheel (12) describes a circular trajectory movement, the serrated shape (15) and the output disc (18) then being rigidly linked or forming one and the same piece. Similarly, the gear wheel (12) may have two non-coplanar toothing profiles (13), one cooperating with the serrated shape (15) and the other cooperating with a second serrated shape rigidly linked to the output disc, the axial extensions (17) and the cavities (16) then being removed.

The housing (14) has radial extensions complementary to radial extensions of the flange (1) and having fixing eyelets (36) intended to secure the gear motor according to the present disclosure to any external member linked to the application.

Therefore, the housing (14) has, on the front of the gear motor, a guide (20) receiving a rolling bearing (21) guiding the output shaft (19) in rotation about the axis of rotation of the machine, the output shaft being extended at the front by a connection shaft (22) to any external member linked to the application of the gear motor. The output shaft (19) is extended toward the rear of the gear motor so as to pass through the interior of the rotor assembly (26) and the interior space (6). The output shaft (19) is guided at the rear of the gear motor by a main bearing (25) formed by an extension of the overmolding of the stator assembly (2) performing this guiding function directly without any added guide element. In this embodiment, the output shaft (19) of the movable gearing assembly is connected by a connection shaft (22) to an external member; however, this direct connection mode is not limiting with respect to the present disclosure and any type of indirect variants obvious to those skilled in the art are contemplated. By way of example, the output shaft (19) of the movable gearing assembly could be coupled to the input wheel of a second movable gearing assembly articulated about, for example, an axis parallel or perpendicular to the output shaft (19), the output of this second movable gearing assembly being able to be secured to a means of connection to an external member.

The output shaft (19), according to a feature of the present disclosure, guides the rotor assembly (26) of the machine in rotation, here owing to the use of two needle roller bearings (23) inside the stator assembly (2). In this way, the rotor assembly (26) has effective guidance, over a large part of its length, provided by the output shaft (19).

On its rear end, the output shaft (19) supports a magnet (7) axially facing a magneto-sensitive detection probe (24) used to detect the angular position of the output shaft (19). Position detection is not limited to a magnet/probe pair; other embodiments can be employed, such as inductive-type detection mechanism (not shown).

In another embodiment not illustrated here, in order to gain in compactness and/or resistance, the rolling ball guide elements, the inner and/or outer guide tracks of the rolling bearings (11) or of the needle roller bearings (23) can be made directly in the support parts, the support parts possibly being the output shaft (19), the support (9) or the toothed wheel (12).

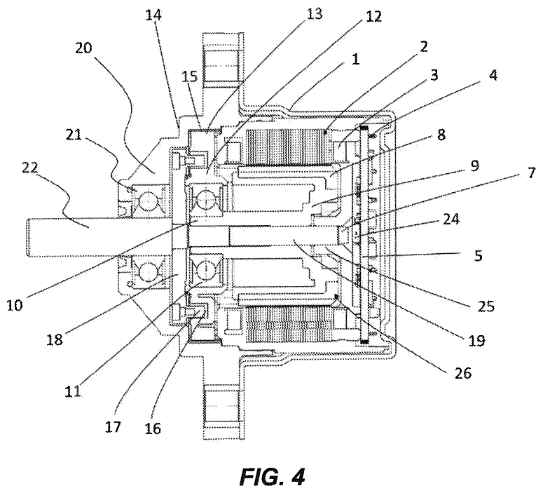

FIG. 3 shows a second embodiment of a gear motor according to the present disclosure, very similar to the first embodiment shown in FIGS. 1 and 2. This variant differs from the first embodiment by two elements. Indeed, at the rear of the gear motor and the output shaft (19), an additional guide element (251), here of the rolling bearing type, is inserted between the main bearing (25), which here serves as a bore for receiving the additional guide element (251), and the output shaft (19). In addition, the guiding of the rotor assembly (26) on the output shaft (19) is achieved by sliding the former onto the latter, this embodiment then dispensing with the needle roller bearings (23) of the first embodiment. Any additional guide element (251) other than a rolling bearing that a person skilled in the art would choose, depending on the functional constraints, can be envisaged.

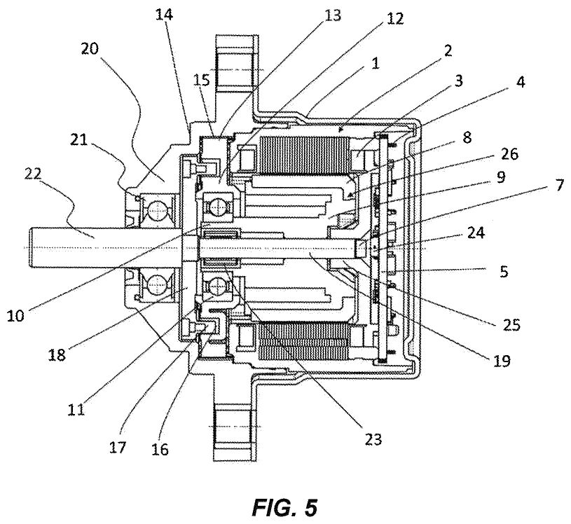

FIG. 4 shows a third embodiment of a gear motor according to the present disclosure, very similar to the first embodiments shown in previous figures. This variant differs from these embodiments in that the rolling bearings (23) described above are removed. In this variant, the rear of the output shaft (19) is guided by the extension of the overmolding forming a main bearing (25), as shown in FIG. 1, and the rotor assembly (26) is guided by the output shaft (19) by sliding, as shown in FIG. 3. This minimalist, and simplest and most economical, configuration will be preferred, in particular, when the cost constraint is significant and when the transverse forces and the torque applied to the output shaft are the least significant.

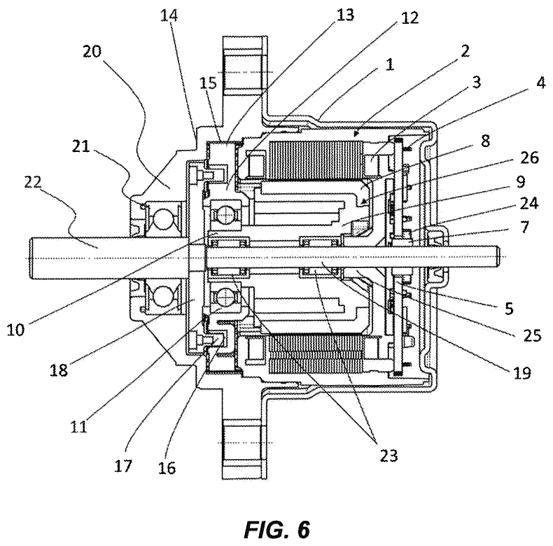

FIG. 5 shows a fourth embodiment of a gear motor according to the present disclosure, very similar to the first embodiment shown in FIGS. 1 and 2. This variant differs from the first embodiment in that the rear needle roller bearing (23) is removed and the rear guidance of the rotor assembly (26) by the output shaft (19) is achieved by sliding the former on the latter in order to propose an interesting cost and performance compromise, the guidance by rolling elements at the eccentric absorbing the majority of the radial forces passing through the reduction gear.

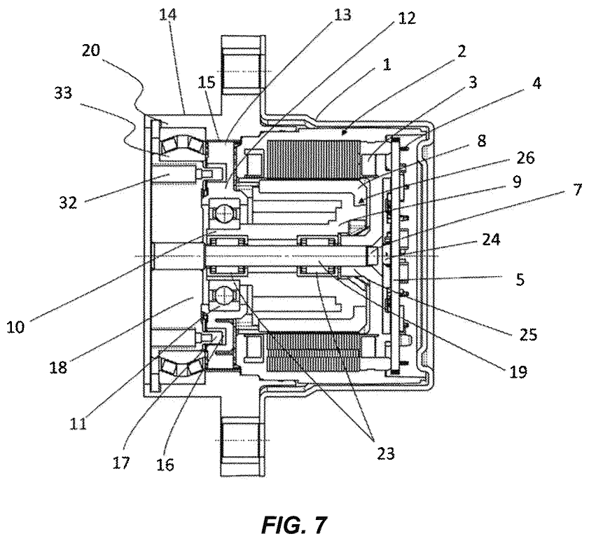

FIG. 6 shows a fifth embodiment of a gear motor according to the present disclosure, very similar to the first embodiment shown in FIGS. 1 and 2. This variant differs from the first embodiment in that the printed circuit (5) and the flange (1) have an opening through which the output shaft (19) passes so as to emerge at the rear end of the gear motor in order to provide a double outlet. In this embodiment, the magnet (7) is a ring secured to the output shaft (19) and radially faces the magneto-sensitive detection probe (24) used to detect the angular position of the output shaft (19), such as International Patent Application Publications WO2007057563A1 or WO2007099238A1. In the present disclosure, the position detection is not limited to a magnet/probe pair, and other embodiments are known in the art and may be employed, in an axial or radial configuration, such as inductive-type detection or detection by optical sensor.

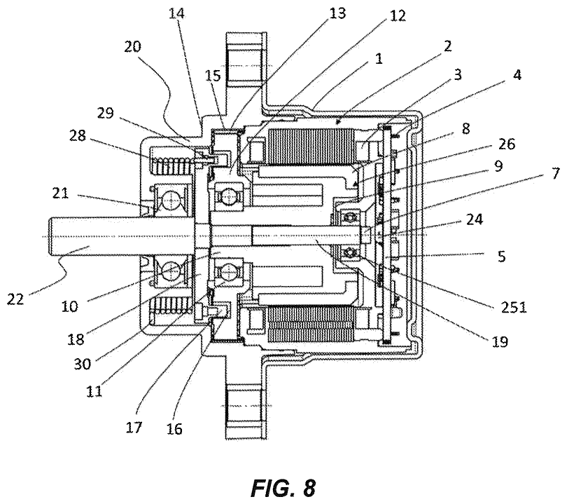

FIG. 7 shows a sixth embodiment of a gear motor according to the present disclosure, very similar to the first embodiment shown in FIGS. 1 and 2. This variant differs from the first embodiment in that the output shaft (19) is not extended by a connection shaft (22), and the output disc (18) is directly fixed to the system to be controlled using screws inserted into tapped holes (32) of the output disc (18). This embodiment makes it possible to absorb transverse forces as well as transmission and tilting torques on the output shaft (19) that are greater than for the first embodiment. For this reason, this embodiment provides for replacing the rolling bearing (21) with a rolling bearing (33) of larger diameter with a double row.

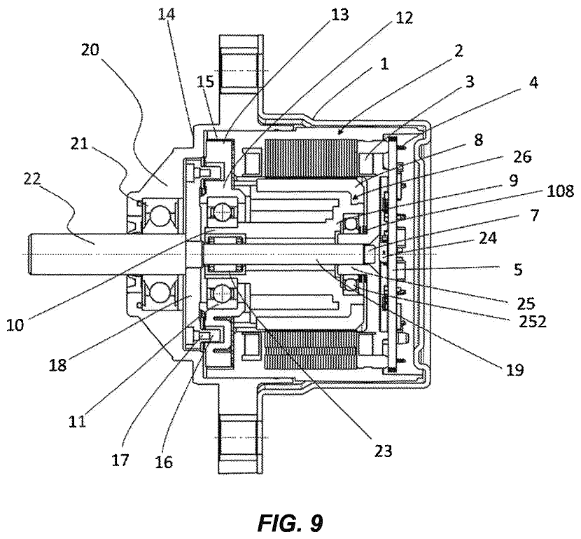

FIG. 8 shows a seventh embodiment of a gear motor according to the present disclosure, very similar to the second embodiment shown in FIG. 3. This variant has a failure prevention function commonly called “failsafe.” In this embodiment, this function is obtained by the action of a spring (28) housed in the guide (20). The spring (28) is secured to the housing at one end (30) and secured to the output disc (18) at its other end (29). Advantageously, in the event of failure of the gear motor, the action of the spring (28) has the effect of bringing the output shaft (19) back into a chosen angular position. However, the incorporation of the spring limits the total angular travel of the output shaft (19) of the gear motor described by the present disclosure.

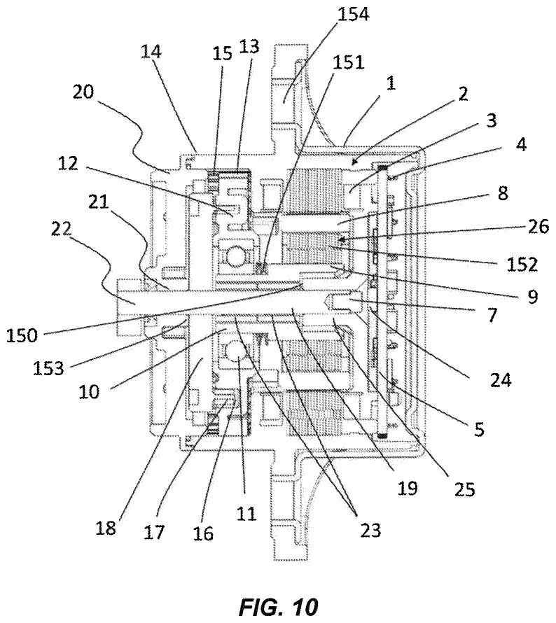

FIG. 9 shows an eighth embodiment of a gear motor according to the present disclosure, very similar to the first embodiment shown in FIGS. 1 and 2. This variant differs from the first embodiment in that the rear needle roller bearing (23) is removed. The guiding of the rear part of the rotor assembly (26) is ensured by way of a rolling bearing (252), the inner part of which is secured to the outer periphery of the extension of the overmolding, and which is inserted in a bore of the rear part of the rotor assembly (26). A spring (108) provides an axial pre-stress of the assembly. Advantageously, this pre-stress takes up assembly play, avoids parasitic tilting of the disc (12), and thus prevents the gear motor from premature wear or even the generation of parasitic noise by ensuring proper engagement of the teeth. The axial pre-stress can also be reinforced or entirely produced using the magnetic ring (8) of the rotor assembly (26) deliberately not axially centered with respect to the stator assembly (4); an axial magnetic force is then created, the magnetic ring (8) naturally refocusing on the stator assembly (4).

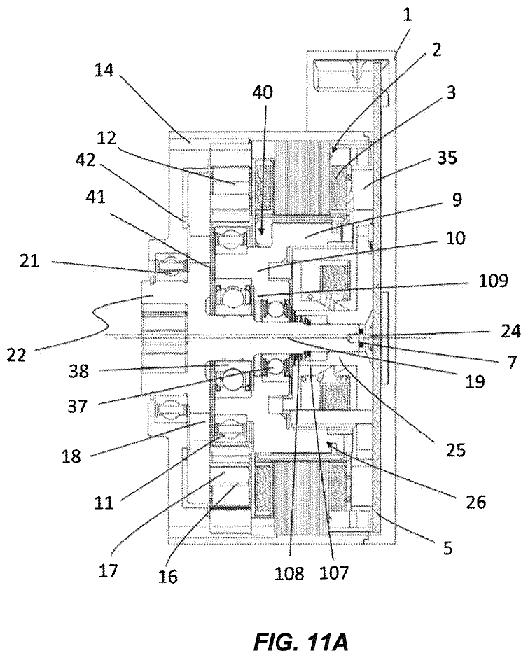

FIG. 10 shows a ninth embodiment of a gear motor according to the present disclosure, very similar to the first embodiment shown in FIGS. 1 and 2. This variant differs from the first embodiment in that the axial compactness is greatly increased. For this purpose, the needle roller bearings (23) are arranged in series and the front guide (20) has a disc shape. In order to cancel the play and stabilize the potentially noisy elements of the reduction gear, an elastic washer (151) is placed between a shoulder of the support (9) of the rotor assembly (26) and the rolling bearing (11), the rolling bearing (11) being slidably mounted on the support (9). The rotor assembly (26) is then pressed against the extension of the overmolding of the stator assembly (2). A friction washer (150) is then arranged between the support (9) and the extension so as to limit friction losses between these two elements in relative rotation. Symmetrically, the elastic washer (151) cancels the axial play between the gear wheel (12) and the output disc (18), which would cause noise and premature wear of these parts. The output disc (18) is then in axial abutment against an annular extension (153) of the guide (20), the relative speed between these parts being low; the friction is controlled by a proper dimensioning of the elastic washer (151). This embodiment also differs in that the housing (14) is an integral part of the stator overmolding. Finally, by way of illustration, in this variant embodiment the rotor assembly comprises a sheet metal package (152) on which a magnetic ring (8) is secured by, for example, gluing; the sheet metal package (152) is then secured to the support (9).

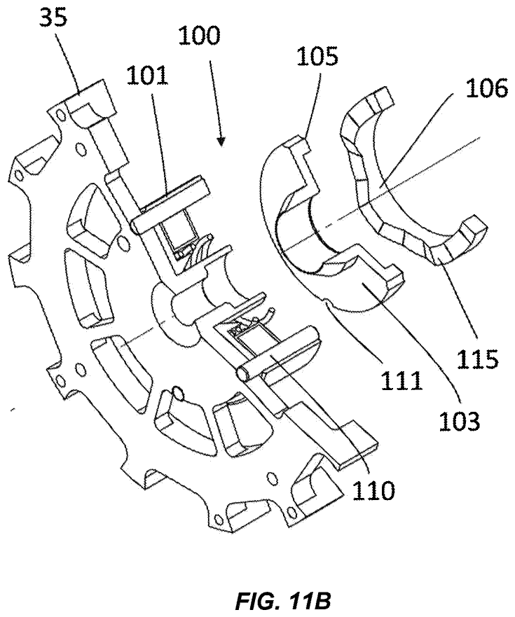

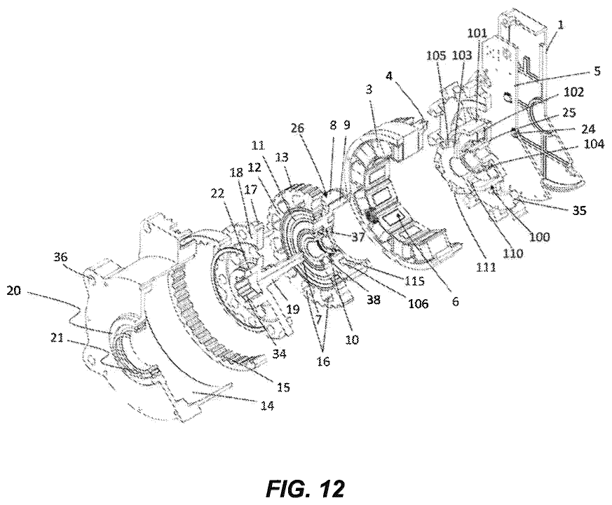

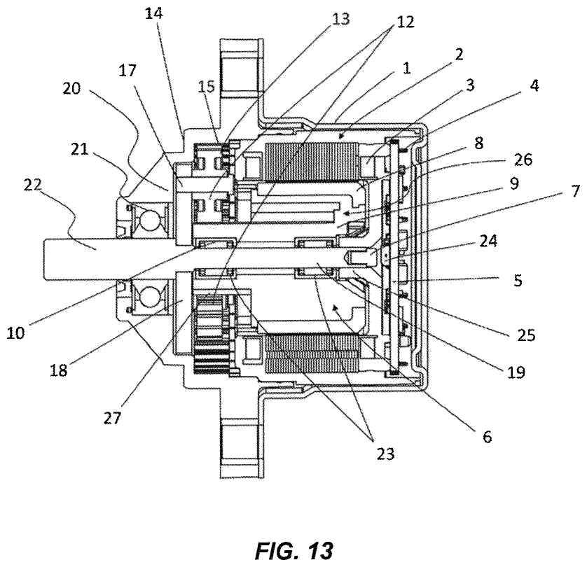

FIGS. 11A, 11B and 12 show a tenth embodiment according to the present disclosure, similar to the first embodiment shown in FIGS. 1 and 2. This embodiment is a particularly compact variant in the axial direction. This variant differs from the first embodiment in that the needle roller bearings (23) are removed and the guiding of the rotor assembly (26) by the output shaft (19) is provided by way of two rolling bearings (37) and (38) inserted into bores of the hollow shaft (10) of the rotor assembly (26). The rolling bearing (37) receives an axial force from a spring (108) constrained at its other end by a washer (107) secured to the output shaft (19). This axial force is transmitted by the rolling bearing (37) to the shaft (10) of the support (9) of the rotor assembly (26) via a stop (109), so as to generate an axial force ensuring the pre-stress of the gear wheel (12) secured to the shaft (10) of the rotor assembly (26) on the output disc (18) secured to the output shaft (19). Advantageously, this pre-stress takes up assembly play, avoids parasitic tilting of the disc (12), and thus prevents the gear motor from premature wear or even the generation of parasitic noise by ensuring proper engagement of the teeth. Similarly, the axial play and the tilting of the output assembly (18), (19) and (22) can be limited by limiting the axial play by way of the stop ring (41) and a friction disc (42) attached or made by the housing (14). This variant embodiment also differs in that the connection shaft (22) provides interfacing via a splined cavity (34), and in that the stator assembly (2) comprises a guide flange (35) to ensure the rear guiding of the output shaft (19), these embodiments not, however, being limiting with respect to the present disclosure.

A balancing of the mechanical unbalance inherent in the eccentric rotation of the gear wheel (12) is carried out in order to limit the vibrations of the system. In this embodiment, this balancing is obtained by a judicious removal of material (40) carried out on the magnet support (9). This embodiment is not limiting, and other balancing means such as adding material are also considered.

This alternative embodiment also differs from the first embodiment in that the flange (1) is not secured to the housing (14) by the fixing eyelets (36), but by screws directly housed in the overmolded stator assembly (31).

Finally, this variant differs from the first embodiment in that it incorporates a brake and safety locking system. For this variant, this function is ensured by the addition in the interior space (6) of a monostable magnetic actuator (100), but the present disclosure is not limited to this technology. The magnetic actuator (100) comprises a ferromagnetic bell (101) having an inner annular extension. Since the inner annular extension is assembled without clearance on the guide flange (35) of the stator assembly (2), the inner part of the guide flange (35) forming a main bearing (25) guides the output shaft (19). The ferromagnetic bell (101) is closed by a ferromagnetic disc part (103) that is mounted with play on the same outer part of the extension of the overmolding and that is guided in translation by an axial irregularity (110) of the bell (101) cooperating with a complementary shape (111). The discal part (103) has an axial toothing (105) on its outer periphery that cooperates with a ring gear (106) inserted into an annular recess of the shaft (10) and having a complementary toothing (115), so as to block the rotation of the rotor assembly (26) when the teeth (105, 115) are nested. The magnetic actuator (100) is characterized in that, in the rest or fault state, the interlocking of the teeth (105, 115) is ensured by a spring (104) inserted into the internal cavity of the bell (101) and coaxial with the output shaft (19), the spring (104) being in axial bearing at one of its ends on the radial development of the bell (101) and at the other end on the radial development of the disc portion (103). Advantageously, an annular winding (102), inserted into the cavity of the bell (101) and secured to the bell, generates a magnetic force of attraction between the bell (101) and the disc part (103) when it is traversed by a current. The magnetic force opposes the force of the spring and makes it possible to eliminate the contact between the two ring gears. Advantageously, the intensity of the current passing through the winding (102) allows the magnetic actuator (100) to modulate the friction between the teeth (105, 115) so as to brake the rotor assembly (26) by dog clutch.

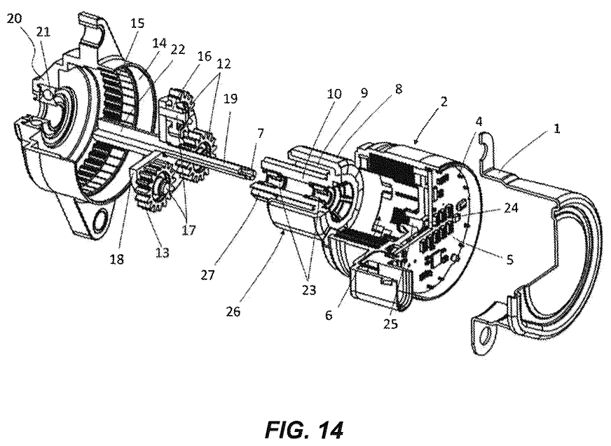

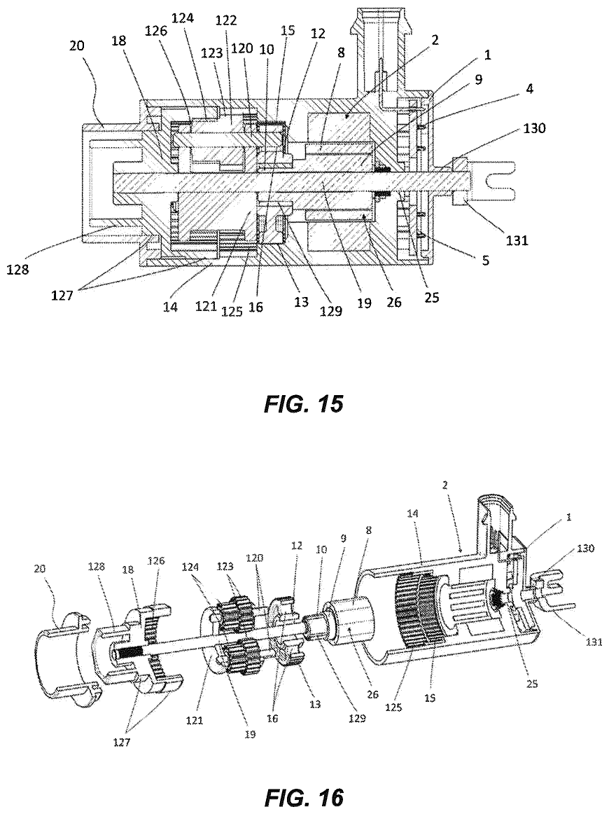

FIGS. 13 and 14 show an eleventh embodiment of a gear motor according to the present disclosure, very similar to the first embodiment shown in FIGS. 1 and 2. This variant differs from this embodiment in that the reduction gear is of the epicyclic type. In this embodiment, the rotor assembly (26) no longer drives the gear wheel (12) via the rolling bearing (11), but has a serrated shape (27) at its end that cooperates with the serrated shapes (13) of multiple gear wheels (12). The multiple gear wheels (12) are guided in rotation by axial extensions (17) of the output disc (18) secured to the output shaft (19). The illustrated example does not limit the present disclosure; the number of satellites (12) and the type of epicyclic reduction gear, here of the simple type, can be modified, and the person skilled in the art would also consider integrating a compound train said to be of type 2, 3 or 4 or a nested train.

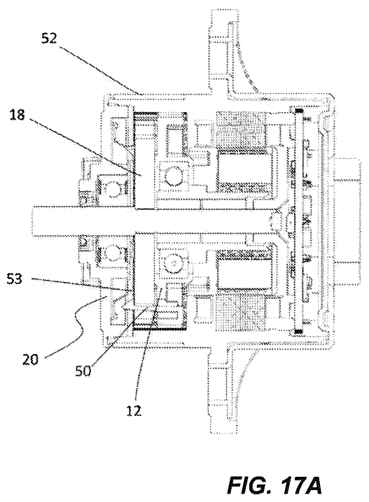

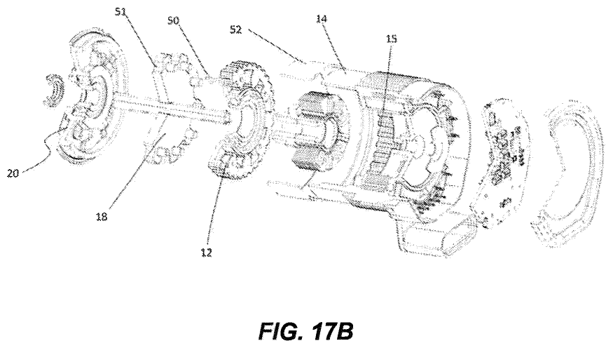

FIGS. 15 and 16 show a twelfth embodiment of a gear motor according to the present disclosure. It differs from previous embodiments in that it comprises two different juxtaposed reduction gear modules, the first being a trochoidal reduction gear and the second, an epicyclic reduction gear. In this embodiment, the rotor assembly (26) is guided by plain bearings on the output shaft (19). The shaft (10) of the rotor support (9) guides a gear wheel (12) eccentrically with respect to the axis of rotation of the rotor assembly (26). The disc-shaped gear wheel (12) has a serrated shape (13) at its periphery.

The housing (14), integrated into the overmolding of the stator assembly (2), has two internal serrated shapes (15, 125), the first serrated shape (15) cooperating with the serrated shape (13) of the gear wheel (12) so that the gear wheel (12) performs a cycloidal movement when driven by the rotor assembly (26) via the eccentric guide ring (129) to form the first reduction stage, the second serrated shape (125) cooperating with multiple planetary gears (122) to form a second reduction stage.

The gear wheel (12) has a set of cavities (16) inside which pins (120) secured to a planet carrier (121) are positioned. The pins each guide a satellite gear wheel (122) having, on its outer periphery, two serrated shapes (123, 124), the first serrated shape (123) cooperating with the second serrated shape (125) of the housing (14).

The output disc (18) has a serrated internal shape (126) cooperating with the second serrated shape (124) of the satellite gear wheels (122). In the present embodiment, the output disc (18) is overmolded on the output shaft (19) and guided by plain bearings (127) on the inner surfaces of the overmolding of the stator assembly (2) and of the guide (20). The output disc (18) also has a protrusion (128) cooperating with a complementary shape of the member to be controlled. The complementary shape of the member to be controlled being guided by the inner surface of the guide (20). The output shaft (19) is guided at the other end of the gear motor, on the one hand, by a protrusion of the overmolding of the stator assembly (2) forming a main bearing (25), and on the other hand, by a protrusion of the flange (1) forming a main bearing (130). At its end, the output shaft (19) is secured to a U-shaped part (131) by stamping. The U-shaped part (131) has a second means of interfacing with the member to be controlled.

In this variant embodiment, all of the guides are produced by plain bearings, but the other alternatives of added parts that the person skilled in the art would consider are not ruled out. By way of example, the guide ring (129) can advantageously be replaced by a rolling bearing so as to limit friction in this critical zone.

Finally, in this embodiment, the housing (14) is an integral part of the stator molding and is not linked to the flange (1) by fixing eyelets (36), not visible here, but by screws directly housed in the overmolded stator assembly (31).

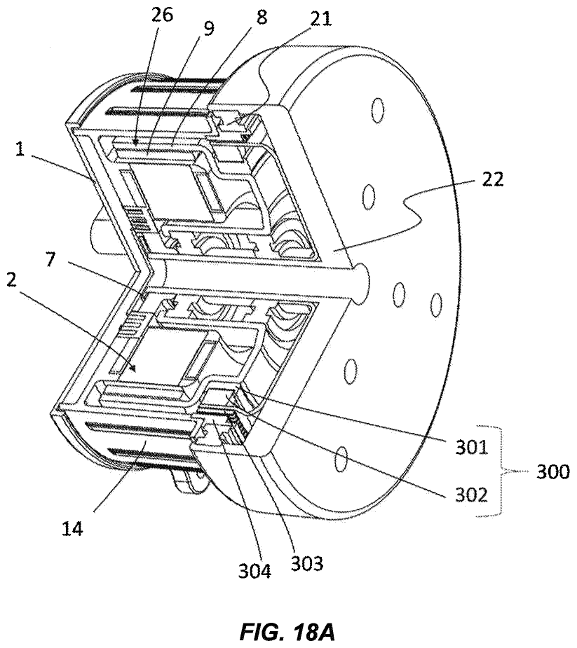

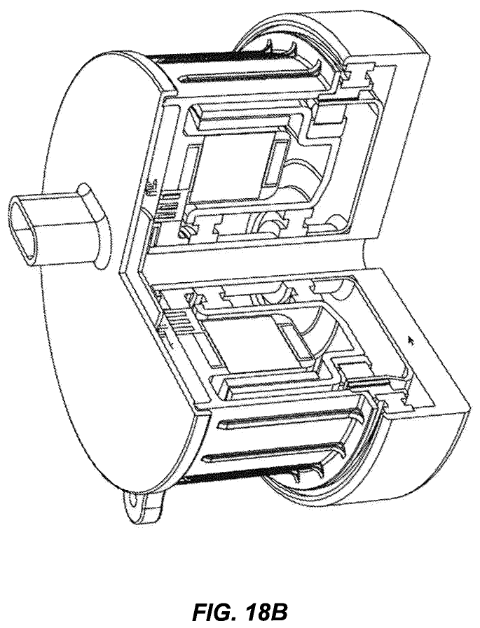

FIGS. 17A and 17B show a thirteenth embodiment, very similar to the embodiment shown in FIG. 10. This variant differs from this embodiment in that the gear wheel (12) comprises deformable hooks (50), suitable for clipping onto a face (53) of the output wheel (18), passing through cavities (51), so as to eliminate the axial degree of freedom between the gear wheel (12) and the output wheel (18). The axial joining of these two parts prevents the appearance of vibrations and premature wear that accompany them and limits the misalignment penalizing the operation of the reduction gear. The use of hooks (50) integrated into the gear wheel (12) is not limiting with respect to the present disclosure, the hooks (50) alternatively being able to be integrated into the output wheel (18) and the cavities (51) into the gear wheel (12), but the person skilled in the art could also imagine all sorts of solutions aimed at constraining the axial displacement between the output wheel (18) and the gear wheel (12) while leaving free mobility in an orthogonal plane.

This embodiment also differs in that a ring (52) made of a very rigid material, such as steel, is inserted on the outer periphery of the housing (14) at the serrated internal shape (15), so as to compensate for the radial deformations of the housing (14) due to the forces between the gear wheel (12) and the serrated internal shape (15). This ring (52) is particularly useful when the serrated internal shape (15) is an integral part of a plastic housing (14). The use of such a ring (52) is nevertheless not conditional on the use of plastic materials, but can be envisaged as soon as the forces involved are too great and risk deforming the serrated internal shape (15). The use of such a ring (52) is not limited to the presented embodiment and can be attached to the periphery of the stator assembly (2) when the serrated internal shape (15) is produced directly in its overmolding.

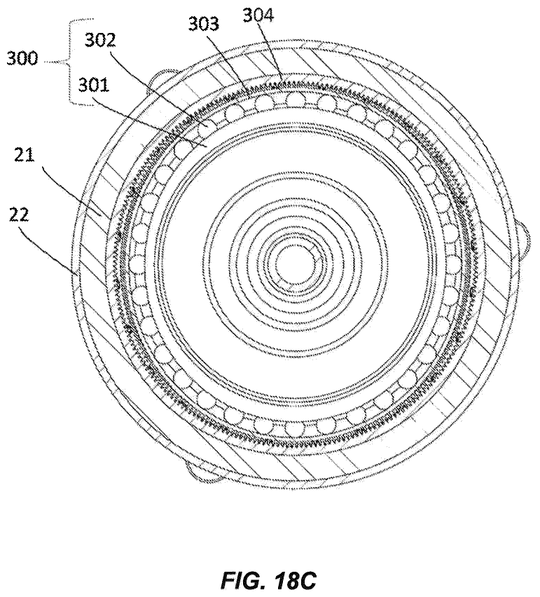

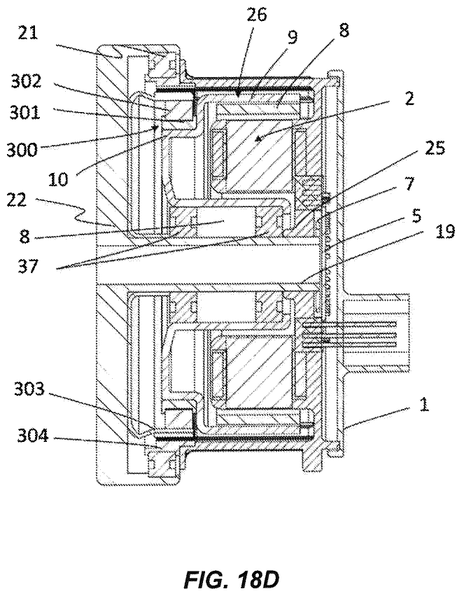

FIGS. 18A-18D show a fourteenth embodiment. It differs from previous embodiments in that it comprises an external rotor motor and a so-called strain wave or elliptical reduction gear. In this embodiment, the rotor assembly (26) is sandwiched by the stator assembly (2), the latter also performing the function of an overmolded housing (14), this embodiment not, however, being limiting, the housing being able to be a separate part and attached to the stator assembly. The rotor assembly (26), and more particularly the magnetic ring (8), cooperates magnetically with the field created by the coils (3) of the stator assembly (2) on the outer radial periphery of the stator. Furthermore, the rotor assembly (26) is guided at least partly in the interior space (6) of the stator assembly (2) by rolling bearings (37), or plain bearings, inserted between the support (9) of the rotor assembly (26) and the output shaft (19). The output shaft (19) in turn being guided by a main bearing (25) or by way of a rolling element (not shown). The shaft (10) of the rotor support (9) guides an elliptical plate (300) comprising an elliptical hub (301) supporting a special rolling bearing (302) deforming the external toothed deformable bush (303), which meshes with the inner ring gear (304). The latter can be attached, molded or form an integral part of the stator assembly (2) or of the housing (14). The elliptical plate (300) driven in rotation deforms the toothed bush (303), which has a slightly lower number of teeth, generally two fewer teeth, than the inner ring gear (304). As illustrated here, the inner ring gear (304) is usually static and the reduced output movement is taken up by the deformable bush (303), here linked to the connection shaft (22) forming a large-diameter plate allowing the transmission of high loads to the member to be controlled and thereby performing the closure of the actuator. Alternatively, obviously for those skilled in the art, the bush (303) can be locked in rotation and the output movement can then be transmitted by the inner ring gear (304). The connection shaft (22) here is guided by a large-diameter rolling bearing (21) advantageously located close to the meshing plane of the reduction gear and able to seal the system directly (or via a dynamic seal, not illustrated). The shaft (19), shown here, is hollow for the purpose of reducing the mass of the system. Alternatively, in the event of drilling the flange (1) and printed circuit (5) (or a lead-frame), the hollow shaft (19) can make it possible to obtain an output on each side of the actuator and/or allow the passage of a fluid, cables, axis, etc., through the actuator. The person skilled in the art could obviously use another type of reduction gear, such as that of the trochoidal or epicyclic type, or another type of motor, with an internal rotor as described in the other embodiments, but also with axial flux, such as, for example, taught in International Patent Application Publication WO1992011686.

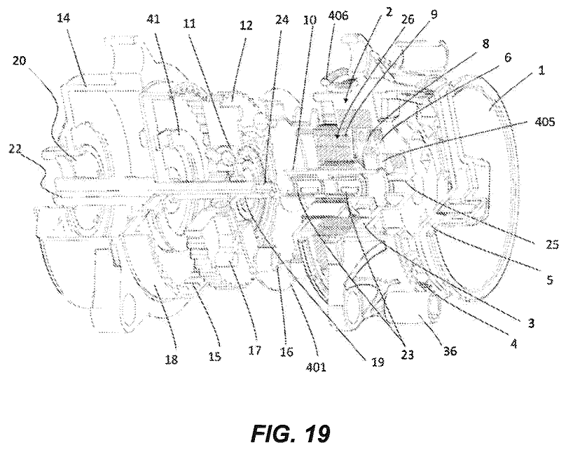

FIG. 19 shows an exploded view of a fifteenth embodiment. This is a variant of the first embodiment for which the gear wheel (12) has axial extensions (17) cooperating with cavities (16) here made in an insert (401) rigidly connected to the stator assembly (2). Thus, the eccentric shaft (10) drives the disc (12) with a circular translational movement and the reduced rotational movement is then taken up by the serrated internal shape (15), then rigidly linked to the output disc (18) in order to form a single piece; the latter here advantageously surrounds the serrated shape (15) in order to stiffen it and limit its ovalization under load. Obviously for those skilled in the art, the cavities (16) can be made directly in the disc (12) or via one or more inserts, and the axial extensions (17) can be made by the insert (401). Alternatively, the insert(s) (401) can be clipped, screwed or molded into the housing (14) or into the stator assembly (2), the cavities (16) or axial extension (17) being able to be produced directly by way of the overmolding of the disc (12) or of the stator assembly (2).

In this variant, the rotor assembly (26) is produced by way of magnet blocks in a magnetic ring (8) inserted into the ferromagnetic yoke (9), which in turn is driven or molded onto the shaft (10).

This variant also has an encoder (405) that can be magnetic, ferromagnetic or of the optical barrier type, used here to obtain the position of the rotor assembly (26) via a probe or sensor (not shown) linked to the printed circuit (5) or placed independently.

Finally, this embodiment variant uses a seal (406) making it possible to ensure the seal between the housing (14) and the stator assembly (2), which is molded here.

1. A gear motor, comprising:
a housing;
an electric motor having a cylindrical wound stator assembly forming a free interior space and a rotor assembly guided inside the interior space, the stator assembly secured to the housing; and
a mechanical speed reduction gear, the reduction gear located inside the housing and having a movable gearing assembly, an output of the movable gearing assembly being secured to a movement output shaft, an input element of the movable gearing assembly being driven by the rotor assembly and extending inside the housing, the gear motor comprising a guide element of the output shaft, the output shaft being extended inside the motor up to a guide element located at least partly inside the stator assembly, wherein the rotor assembly is guided by a guide means positioned between the inner surface of the rotor assembly and a surface of the output shaft.

2. The gear motor of claim 1, wherein the guide means comprises a rolling bearing or a plain bearing.

3. The gear motor of claim 1, wherein the guide means comprises a coaxial combination of a rolling bearing and a tubular sleeve of a flange secured to the stator assembly.

4. The gear motor of claim 1, wherein the stator assembly is overmolded with an injectable plastic material forming a support element in the interior space for guiding the output shaft, the guide support element comprising either a plain bearing obtained by a cylindrical bore made directly in the overmolding of the stator assembly, or an insert bearing.

5. The gear motor of claim 4, wherein the housing and the overmolding are extended laterally by corresponding fixing eyelets.

6. The gear motor of claim 4, wherein the overmolded stator assembly is inside a flange, the housing and the flange being extended laterally by corresponding fixing eyelets.

7. The gear motor of claim 1, further comprising a fixed serrated internal member secured to the housing.

8. The gear motor of claim 7, wherein the fixed serrated internal member of the housing comprises an integral portion of the housing, or in an overmolding of the stator assembly.

9. The gear motor of claim 8, further comprising a rigid ring inserted at an outer periphery of the serrated internal member.

10. The gear motor of claim 1, further comprising a serrated internal member on an output disc secured to the output shaft, the serrated member cooperating with a gear wheel having axial extensions or cavities cooperating with cavities or axial extensions secured to the housing so as to allow eccentric rotation of the gear wheel.

11. The gear motor of claim 10, wherein the mechanical reduction gear comprises a trochoidal reduction gear, the input element of the movable gearing assembly comprising a gear wheel having a serrated shape on a periphery of the gear wheel cooperating mechanically with the serrated internal member.

12. The gear motor of claim 10, wherein the mechanical reduction gear comprises an epicyclic reduction gear.

13. The gear motor of claim 10, wherein the mechanical reduction gear comprises an elliptical reduction gear or a strain wave reduction gear.

14. The gear motor of claim 13, wherein the output element of the movable gearing assembly is an output disc secured to the output shaft, the output disc and the gear wheel being axially secured using hooks.

15. The gear motor of claim 1, wherein the output element of the movable gearing assembly is an output disc secured to the output shaft, the rotor assembly and the output disc being axially pre-stressed.

16. The gear motor of claim 1, further comprising a printed circuit located between the stator of the stator assembly and a flange on a rear of the stator assembly.

17. The gear motor of claim 16, wherein the printed circuit comprises a magneto-sensitive probe located and configured to cooperate with a magnet secured to the output shaft.

18. The gear motor of claim 1, further comprising a magnetic actuator in the interior space configured to brake rotation of the rotor assembly modulated by a power supply.

19. The gear motor of claim 18, wherein the magnetic actuator is configured to block rotation of the rotor assembly in the event of a fault in the power supply.

20. The gear motor of claim 18, wherein the magnetic actuator is configured to allow the rotor assembly to rotate in the event of a power supply failure.
